(19) United States
(12) Patent Application Publication
(10) Pub. No.: US 2026/0089404 A1
(43) Pub. Date: Mar. 26, 2026

(54) LIGHT IMAGER USING DIGITAL ADAPTIVE INTEGRATION TIME WITH HYBRID PIXEL

(71) Applicant: L3Harris Technologies, Inc., Melbourne, FL (US)

(72) Inventor: Jeffery BECK, Philomath, OR (US)

(21) Appl. No.: 18/896,261

(22) Filed: Sep. 25, 2024

(51) Int. Cl. H04N 25/53; H04N 23/71; H04N 25/57

(52) U.S. Cl. CPC H04N 25/53; H04N 23/71; H04N 25/57

(57) ABSTRACT

A method of measuring light energy received by a pixel of an imager, comprises: converting the light energy to an electrical signal; dividing an integration period into time intervals identified by digital scaling codes; integrating the electrical signal across the time intervals into an integrated voltage; while integrating, repeatedly comparing the integrated voltage against a threshold at each time interval until, at a particular time interval, a result of comparing indicates that the integrated voltage exceeds the threshold; and when the integrated voltage exceeds the threshold: stopping integrating the light energy received by the pixel at a final voltage; digitizing the final voltage to a digital value; identifying a particular digital scaling code for the particular time interval; and computing a light measurement based on the digital value and the particular digital scaling code.

### TECHNICAL FIELD

The present disclosure relates to high dynamic range light imagers.

### BACKGROUND

A light imager (e.g., a focal plane array) includes an array of pixels that convert light energy to electrical signals. The light imager includes hybrid (e.g., analog and digital) read-out integrated circuits (ROICs) integrated with the pixels to assist with light measurements and read-out of the light measurements from the array. Due to the hybrid nature of the pixels and the ROICs, achieving light measurements over a wide dynamic range, while maintaining a high signal-to-noise ratio (SNR), and low power consumption presents a challenge. The analog components can consume relatively high power and occupy a relatively large volume of on-chip space.

### BRIEF DESCRIPTION OF THE DRAWINGS

FIG. 1 is a block diagram of an example high dynamic range (HDR) imager that implements a digital adaptive integration technique (referred to simply as “digital adaptive integration”) to extend a dynamic range of light measurements made by pixels of the HDR imager.

FIG. 2 shows example operations performed by the HDR imager to convert light energy received by a pixel to a digital light measurement in a way that avoids light saturation of the pixel and associated ROICs.

FIG. 3 shows example waveforms for timing signals and digital scaling codes (DSCs) employed by the HDR imager to convert light energy to the digital light measurement.

FIG. 4 shows a graph of example digital adaptive integration performed by a pixel across an integration period for low intensity light received by the pixel.

FIG. 5 shows a graph of example digital adaptive integration performed by the pixel across the integration period for medium intensity light received by the pixel.

FIG. 6 shows a graph of example digital adaptive integration performed by the pixel across the integration period for high intensity light received by the pixel.

FIG. 7 is a circuit diagram of the pixel according to an embodiment.

FIG. 8 is a block diagram of an example controller configured to perform operations described herein.

### DESCRIPTION OF EXAMPLE EMBODIMENTS

### Overview

In an embodiment, a method of measuring light energy received by a pixel of an imager, comprises: converting the light energy to an electrical signal; dividing an integration period into time intervals identified by digital scaling codes; integrating the electrical signal across the time intervals into an integrated voltage; while integrating, repeatedly comparing the integrated voltage against a threshold at each time interval until, at a particular time interval, a result of comparing indicates that the integrated voltage exceeds the threshold; and when the integrated voltage exceeds the threshold: stopping integrating the light energy received by the pixel at a final voltage; digitizing the final voltage to a digital value; identifying a particular digital scaling code for the particular time interval; and computing a light measurement based on the digital value and the particular digital scaling code.

### Example Embodiments

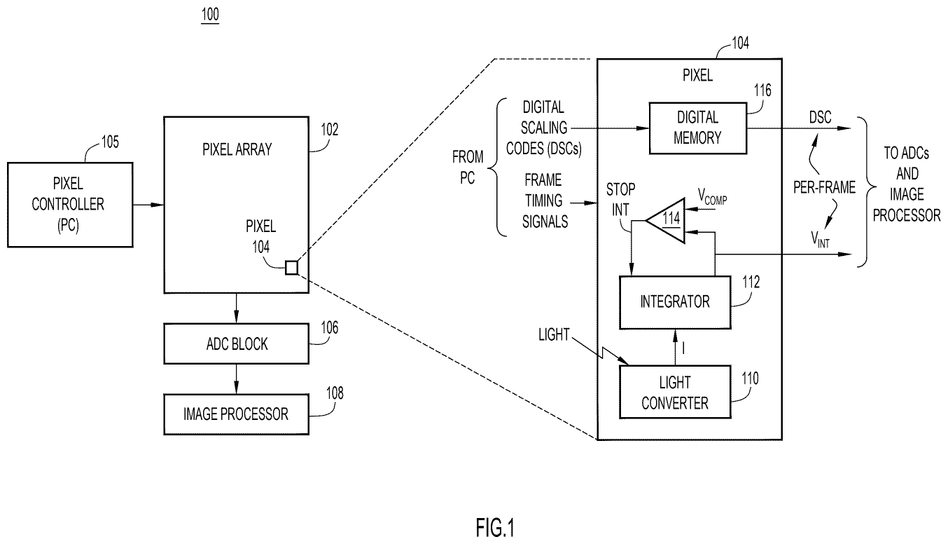

FIG. 1 is a block diagram of an example high dynamic range (HDR) imager 100 (also referred to as an “HDR light imager”) that implements digital adaptive integration that extends a dynamic range of light measurements made by pixels of the HDR imager. HDR imager 100 includes a pixel array 102 having pixels arranged in a pattern (e.g., a planar pattern), a pixel controller (PC) 105 to control the pixels, an analog-to-digital converter (ADC) block 106 that includes multiple ADCs, and an image processor 108. A pixel 104 of pixel array 102 is shown in detail in FIG. 1. It is understood that pixel array 102 includes many such pixels. Pixel 104 is sometimes referred to as a “pixel circuit” and a “light radiation detection element. ” Pixel controller 105, ADC block 106, and image processor 108 may be referred to as “off-pixel” circuits. On the other hand, circuits of pixel 104 may be referred to as “on-pixel” circuits. FIG. 1 shows pixel array 102, pixel controller 105, ADC block 106, and image processor 108 as separate blocks by way of example, only. It is understood that other arrangements may integrate or combine portions of the foregoing blocks.

Pixel controller 105 generates frame timing signals that establish a timeline of successive frame periods (referred to simply as “frames”). Pixel controller 105 also generates a stream or sequence of integration time-dependent digital scaling codes (DSCs) (also referred to as digital timestamps) associated with the frames. Responsive to the frame timing signals and the DSCs, pixel array 102, ADC block 106, and image processor 108 perform per-frame operations (i.e., operations performed frame-by-frame) that convert light energy (also referred to as a “light signal”) received by the pixels in each frame into an array of digital light measurements (one light measurement per pixel) for each frame. Each digital light measurement may also be referred to as a “digital light intensity value. ” HDR imager 100 repeats the same per-frame operations across successive frames of the timeline to generate successive arrays of light measurements.

Pixel 104 integrates light energy falling on the pixel over an integration period to produce an analog integrated voltage. Then, an ADC of ADC block 106 digitizes the integrated voltage. The integrated voltage has a slope that increases with an intensity of the light energy. Therefore, high intensity light energy can cause the integrated voltage to saturate an analog dynamic range of the pixel and the ADC by the end of the integration period. The digital adaptive integration presented herein avoids such saturation and extends the dynamic range using digital techniques. Briefly, the digital adaptive integration (i) detects when the slope falls in a range that would drive the integrated voltage into saturation by an end of the integration period, (ii) stops the integration of the light energy before the end of the integration period to avoid the saturation, and (iii) then scales-up the “stopped” integrated voltage using a scaling factor that depends on a DSC, as described in further detail below.

Pixel controller 105 provides the same frame timing signals and sequence of DSCs to all the pixels of pixel array 102 for each fame, in parallel. An expanded view of pixel 104 is shown in FIG. 1. Pixel 104 includes a light converter 110 to convert light energy received by pixel 104 to a photodiode current I (also referred to as an “electrical signal”), an integrator 112, a comparator 114, and a digital memory 116. During each frame, integrator 112 integrates the electrical signal over successive time intervals of an integration period, to produce an integrated voltage V_{INT}. Concurrently, comparator 114 periodically compares integrated voltage V_{INT} (also referred to simply as “V_{INT}”) against a voltage threshold V_{COMP} (also referred to simply as “V_{COMP}”) at the conclusion of every time interval. Pixel 104 receives the sequence of the DSCs that coincide in time (i.e., overlap) with, and identify, the time intervals.

When comparator 114 indicates that V_{INT} exceeds V_{COMP} at the end of a particular time interval (which indicates that the slope of V_{INT} can cause saturation by the end of the integration period), integrator 112 stops integrating and holds V_{INT} at a final V_{INT} for the frame, which prevents subsequent saturation. Additionally, digital memory 116 stores a particular DSC of the sequence of the DSCs that coincides with the particular time interval. At the end of the frame, image processor 108 reads from pixel 104 the final V_{INT} through an ADC of ADC block 106, which digitizes the final V_{INT} into a digitized or digital value for the final V_{INT}. Image processor 108 also reads the particular DSC from digital memory 116, and computes a digital light measurement for pixel 104 based on the digital value and a scaling factor that is based on the particular DSC. The digital light measurement represents a digital extrapolation of the digital value over the remaining integration period.

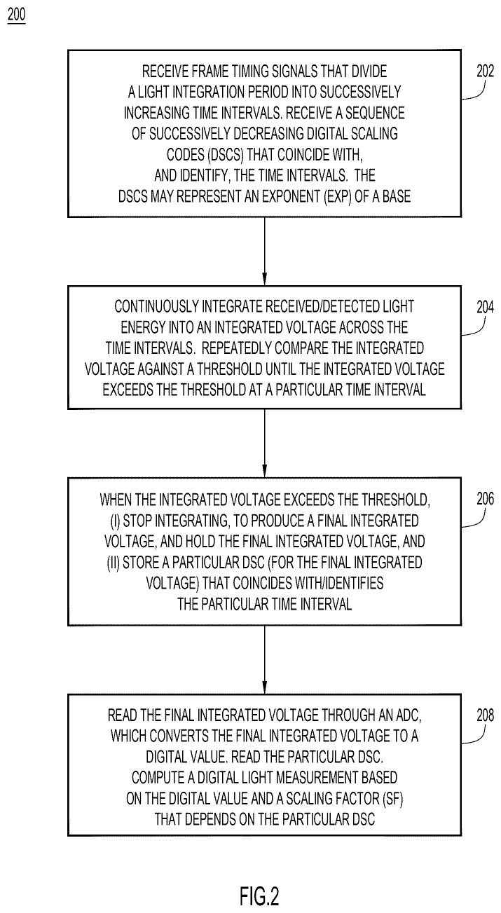

FIG. 2 shows example operations 200 performed by HDR imager 100 to convert light energy received by pixel 104 to a digital light measurement for a frame in a way that avoids light saturation.

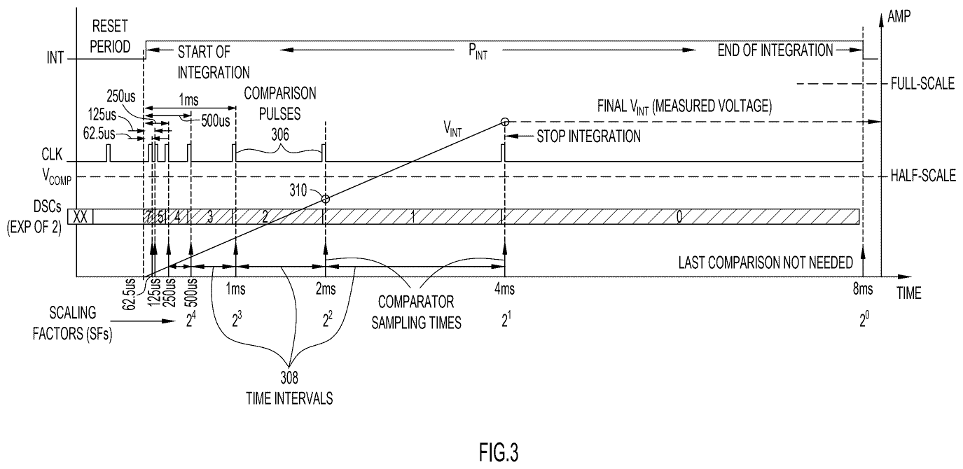

At 202, as described above, pixel controller 105 generates frame timing signals to establish a frame, and also generates a stream of DSCs associated with the frame. Pixel controller 105 provides the frame timing signals and the stream of DSCs to pixel 104, which receives the frame timing signals and the DSCs. FIG. 3 shows example waveforms 300 for the aforementioned signals, which include an integration signal INT, a clock signal CLK, V_{COMP} (which may alternatively be stored locally on pixel 104), and the DSCs. The right-hand-side of FIG. 3 shows an amplitude range for V_{INT} from zero to full-scale. In the example, V_{COMP}=half-scale (i.e., one-half of full-scale), although V_{COMP} may be set to other values that are less than half-scale. The time scale and times of FIG. 3 are provided as examples, only. Other time scales and times are possible.

Integration signal INT starts with a short reset period that marks a start (or near start) of the frame. When the reset periods ends, integration signal INT establishes an integration period P_{INT} that extends until an end (or near end) of the frame. Thus, the reset period is asserted prior to the integration period P_{INT}. Depending on the type of pixel, integration signal INT may be asserted low during the reset period and high during integration period P_{INT} (as shown in the example of FIG. 3), or high during the reset period and low during integration period P_{INT}.

Clock signal CLK includes a sequence of spaced-apart comparison pulses 306 that divide integration period P_{INT} into successively increasing time intervals 308. Comparison pulses 306 mark ends of corresponding ones of time intervals 308. In the example, time intervals 308 include 8 exponentially increasing time intervals, such that each time interval is double the previous time interval.

The DSCs overlap/coincide in time with, and identify (i.e., are associated with), corresponding ones of time intervals 308. That is, the DSCs are assigned to corresponding ones of the time intervals. In the example, the DSCs include 8 successively decreasing (with time) exponents (EXPs) of a base=2, including 7, 6, 5, 4, 3, 2, 1, and 0. Generally, the DSCs may be represented as multibit digital words or codes to be stored in a multibit digital memory (e.g., digital memory 116), for example. In the example, each DSC is a 3-bit code, such as a Gray code. As mentioned above, the digital adaptive integration employs a scaling factor (SF) to extend the light measurement dynamic range of HDR imager 100. The scaling factor SF may be set equal to the base (e.g., 2) raised to a power that is equal to a DSC. That is, scaling factor SF may be computed according to: SF=2^{DSC}. For example, DSCs 0, 1, 2, 3, and so on, result in SFs 2⁰, 2¹, 2², 2³, and so on. Use of the scaling factor SF as a multiplier to extend light measurement dynamic range is described below.

FIG. 2 is described also with continued reference to FIGS. 1 and 3. Returning to FIG. 2, at 204, responsive to the reset period of integration signal INT, integrator 112 resets V_{INT} to zero. Subsequently, integrator 112 continuously integrates the electrical signal (i.e., photodiode current I) into V_{INT} across time intervals 308 of integration period P_{INT}. Consequently, V_{INT} generally rises linearly over time. While integrator 112 integrates the electrical signal, comparator 114 repeatedly compares V_{INT} against V_{COMP} responsive to comparison pulses 306 (i.e., at the ends of time intervals 308), until a particular compare at a particular time interval indicates that V_{INT} exceeds V_{COMP}. The example of FIG. 3 shows two such comparisons 310 and 312 at times of 2 ms and 4 ms that occur responsive to corresponding comparison pulses at those times. At comparison 310, V_{INT} <V_{COMP}, and integrator 112 continuous integrating. On the other hand, at comparison 312, V_{INT} >V_{COMP}, and the integrator stops integrating, as described below.

Returning to FIG. 2, when V_{INT}>V_{COMP} at the particular time interval, at 206, pixel 104 performs the following operations:
a. Integrator 112 stops integrating and holds V_{INT} at a final V_{INT} (i.e., a final measured voltage).
b. Digital memory 116 stores or latches a particular DSC (for final VINT) that coincides with (i.e., overlaps) and identifies the particular time interval. That is, digital memory 116 stores whichever DSC is resting at the input to the digital memory when comparator 114 indicates that V_{INT} exceeds V_{COMP}.

When integration period P_{INT} ends, at 208, image processor 108 reads final V_{INT} from integrator 112 through an ADC of ADC block 106. The ADC digitizes the final V_{INT} to a digital value (i.e., a digitized version of final VINT). Image processor 108 also reads the particular DSC stored by digital memory 116. Image processor 108 computes a digital light measurement based on the digital value and the particular DSC. To do this, image processor 108 computes scaling factor SF according to: SF=2^{DSC}. Next, image processor 108 scales the digital value using scaling factor SF. For example, image processor 108 multiples the digital value by scaling factor SF, to produce the digital light measurement. In this example, the digital light measurement=the digital value⋅SF.

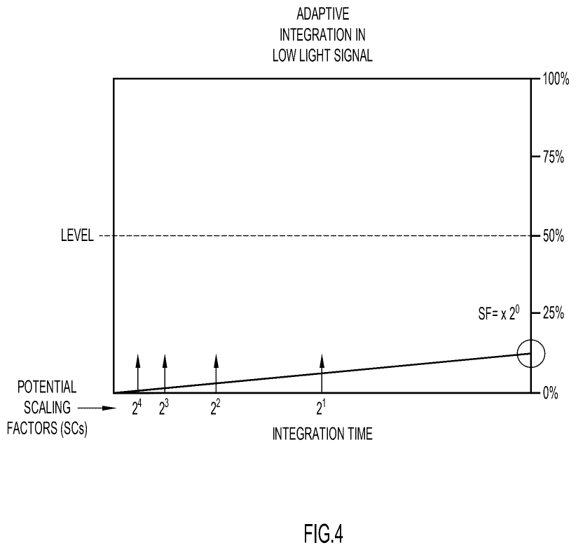

FIG. 4 shows a graph of example digital adaptive integration across integration period P_{INT} when the received light energy has a low intensity (referred to as a “low light signal”). The right-hand-side shows a level of V_{INT} expressed as a percentage of full-scale, which is 100%. In the example, V_{INT} does not exceed V_{COMP} (e.g., 50%) during P_{INT} due to the low intensity. That is, the relatively small slope of V_{INT} keeps V_{INT} below the full-scale. Therefore, integrator 112 is permitted to integrate the electrical signal across the entirety of P_{INT} , which yields DSC=0, and SF=2⁰. Image processor 108 computes: digital light measurement=the digital value for final V_{INT}⋅2⁰.

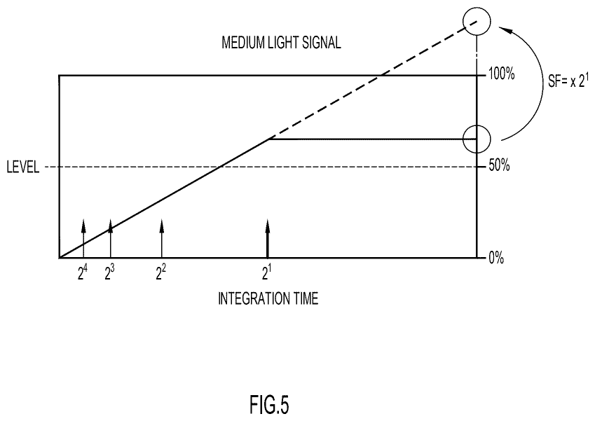

FIG. 5 shows a graph of example digital adaptive integration across integration period P_{INT} when the received light energy has a medium intensity (referred to as a “medium light signal”). In the example, integrated voltage V_{INT} exceeds V_{COMP} at an integration time that coincides with the DSC=1, and SF=2¹. This is an indication that the slope of V_{INT} will cause V_{INT} to saturate. Therefore, integrator 112 stops integrating at that time. Image processor 108 computes the digital light measurement as: digital light measurement=the digital value⋅2¹. The digital extrapolation of V_{INT} is shown as the dashed line.

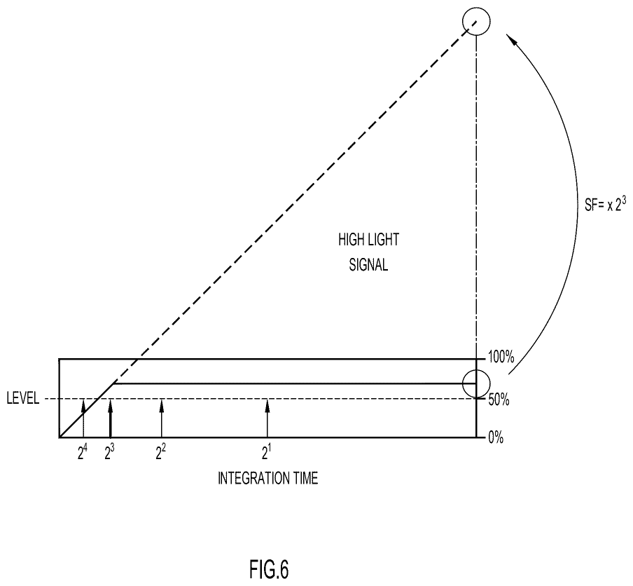

FIG. 6 shows a graph of example digital adaptive integration across integration period P_{INT} when the received light energy has a high intensity (referred to as a “high light signal”). In the example, integrated voltage V_{INT} exceeds V_{COMP} at an integration time that coincides with DSC=3. Therefore, integrator 112 stops integrating at that time. Image processor 108 computes the digital light measurement as: digital light measurement=the digital value⋅2³.

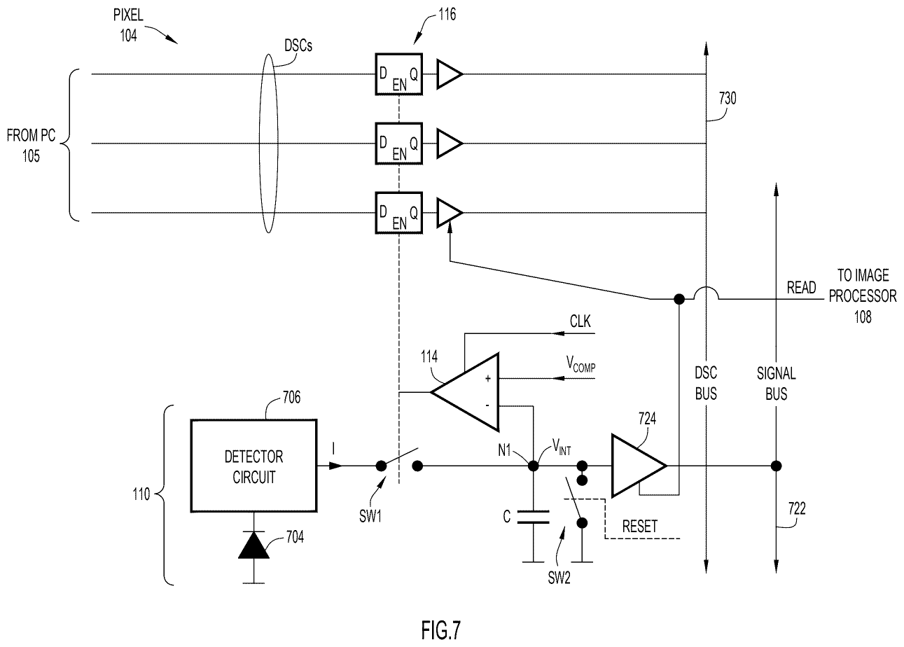

FIG. 7 is a circuit diagram of pixel 104 according to an embodiment. Pixel 104 includes light converter 110 that has a photodetector 704 and a detector circuit 706. Photodetector 704 converts light energy received by the photodetector to photodiode current I (also referred to as the “electrical signal”). Photodetector 704 provides photodiode current I to a node N1 of pixel 104 through detector circuit 706 and a switch SW1. Detector circuit 706 may include an impedance matching circuit and other signal conditioning circuits. Pixel 104 also includes comparator 114, a capacitor C (which serves, in part, as integrator 112) coupled to node N1 and ground, a switch SW2 coupled to node N1 and ground (i.e., across capacitor C). Pixel 104 also includes an analog signal bus 722 coupled to capacitor C through an analog buffer 724, digital memory 116 that has an input to receive the sequence of DSCs and an output coupled to a DSC bus 730. In the example, digital memory 116 includes 3 digital latches to store a 3-bit DSC. Digital memory 116 may be implement as on-pixel memory. The Switch SW1 is controlled by comparison results produced by comparator 114, and switch SW2 is controlled by integration signal INT.

Per-frame operation of pixel 104 is now described. The reset period of integration signal INT closes normally open switch SW2. Capacitor C discharges through closed switch SW2, which clears integration voltage V_{INT} at node N1. After the reset period, switch SW2 opens, and photodiode current I charges capacitor C through normally closed switch SW1. Capacitor C integrates photodiode current I across time intervals 308 of integration period P_{INT}, to produce integration voltage V_{INT} at node N1. While capacitor C integrates photodiode current I to increase VINT, comparator 114 repeatedly compares V_{INT} against V_{COMP} responsive to (e.g., during each of) comparison pulses 306 of clock signal CLK, until, at a particular comparator pulse of a particular time interval, the comparator produces a comparison result (i.e., a stop integration pulse) that indicates that V_{INT} exceeds V_{COMP}.

The stop integration pulse opens switch SW1, which interrupts the flow of photodiode current I to capacitor C. Thus, capacitor C stops further integration of photodiode current I, and thus holds V_{INT} at its present level (i.e., at final V_{INT}). Additionally, the stop integration pulse serves as a write enable on digital memory 116, which causes the digital memory to store a particular DSC resting at the input of the digital memory at that time. The particular DSC coincides in time with and identifies the particular time interval.

When integration period P_{INT} ends, image processor 108 (i) reads final V_{INT} through an ADC of ADC block 106, which converts final V_{INT} to a digital value (i.e., a digital version of final VINT), and (ii) reads the particular DSC stored in digital memory 116. To do this, image processor 108 concurrently asserts a read enable on analog buffer 724 and digital memory 116. Responsive to the read enable, analog buffer 724 transfers final V_{INT} to analog signal bus 722, and the ADC converts final V_{INT} present on the analog bus to the digital value. Responsive to the read enable, digital memory 116 transfers to DSC bus 730 the particular DSC stored in the digital memory. Image processor 108 computes the digital light measurement using the digital value and the particular DSC as described above.

The digital adaptive integration relies on digital signals (e.g., the DSCs), digital circuits (e.g., digital memory 116 and DSC bus 730), and digital/computational scaling of the digitized version of final V_{INT} to extend the dynamic range of pixel 104 using digital techniques. Thus, the digital adaptive integration reduces analog components employed by pixel 104 and the associated ROICs, which advantageously reduces the chip space and power consumed by pixel 104 and the associated ROICs. The reduction in chip space on pixel 104 allows the pixel to use more area for capacitor C to improve its charge collection capacity. The aforementioned savings/improvements scale with the number of pixels implemented in pixel array 102, which may be in the thousands or more. In addition, the digital nature of the digital adaptive integration reduces or eliminates circuit noise that might otherwise corrupt the dynamic range extension provided by the digital adaptive integration computations.

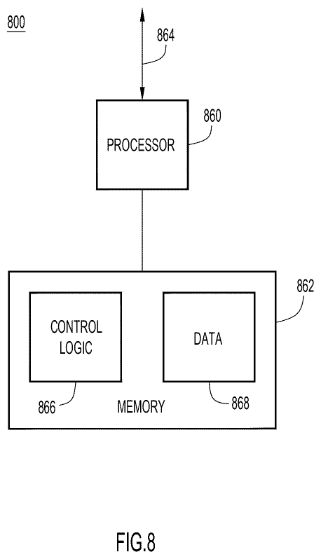

FIG. 8 is a block diagram of an example controller 800 configured to perform operations described herein. Controller 800 may represent pixel controller 105, image processor 108, and one or more control functions of pixel 104. Controller 800 includes processor(s) 860 and a memory 862 coupled to one another. The aforementioned components may be implemented in hardware (e.g., a hardware processor), software (e.g., a software processor), or a combination thereof. Processor(s) 860 communicate with other entities/processes over hardware and/or software interfaces 864.

Memory 862 stores control software 866 (referred as “control logic”), that when executed by the processor(s) 860, causes the processor(s), and more generally, controller 800, to perform the various operations described herein. The processor(s) 860 may be a microprocessor or microcontroller (or multiple instances of such components). The memory 862 may include read only memory (ROM), random access memory (RAM), magnetic disk storage media devices, optical storage media devices, flash memory devices, electrical, optical, or other physically tangible (i.e., non-transitory) memory storage devices. Controller 800 may also be discrete logic embedded within an integrated circuit (IC) device.

Thus, in general, the memory 862 may comprise one or more tangible (non-transitory) computer readable storage media (e.g., memory device(s)) including a first non-transitory computer readable storage medium, a second non-transitory computer readable storage medium, and so on, encoded with software or firmware that comprises computer executable instructions. For example, control software 866 includes logic to implement operations performed by the controller 800. Thus, control software 866 implements the various methods/operations described herein.

In Addition, memory 862 stores data 868 used and produced by control software 866.

In some aspects, the techniques described herein relate to a method of measuring light energy received by a pixel of an imager, including: converting the light energy to an electrical signal; dividing an integration period into time intervals identified by digital scaling codes; integrating the electrical signal across the time intervals into an integrated voltage; while integrating, repeatedly comparing the integrated voltage against a threshold at each time interval until, at a particular time interval, a result of comparing indicates that the integrated voltage exceeds the threshold; and when the integrated voltage exceeds the threshold: stopping integrating the light energy received by the pixel at a final voltage; digitizing the final voltage to a digital value; identifying a particular digital scaling code for the particular time interval; and computing a light measurement based on the digital value and the particular digital scaling code.

In some aspects, the techniques described herein relate to a method, wherein stopping integrating and computing the light measurement using the particular digital scaling code avoids light saturation of the pixel, and increases a light measurement dynamic range of the pixel.

In some aspects, the techniques described herein relate to a method, wherein: the time intervals include successively increasing time intervals; and the digital scaling codes include successively decreasing digital scaling codes.

In some aspects, the techniques described herein relate to a method, wherein: the successively increasing time intervals include exponentially increasing time intervals; the successively decreasing digital scaling codes represent successively decreasing exponents of a base; and computing includes scaling the digital value by a scaling factor equal to the base raised to a power that is equal to the particular digital scaling code.

In some aspects, the techniques described herein relate to a method, further including: receiving the digital scaling codes with corresponding ones of the time intervals, and presenting the digital scaling codes to an input of a digital memory; when the integrated voltage exceeds the threshold at the particular time interval, storing the particular digital scaling code in the digital memory; and when the integration period ends, reading the particular digital scaling code from the digital memory.

In some aspects, the techniques described herein relate to a method, wherein: integrating includes integrating the electrical signal using an integration capacitor.

In some aspects, the techniques described herein relate to a method, further including: prior to the integration period, resetting the integrated voltage to zero.

In some aspects, the techniques described herein relate to a light imager to measure light energy including: a controller to divide an integration period into time intervals identified by corresponding ones of digital scaling codes; a pixel to: convert the light energy to a signal; integrate the signal across the time intervals into an integrated voltage; while integrating, repeatedly compare the integrated voltage against a threshold at each time interval until, at a particular time interval, a result of a compare indicates that the integrated voltage exceeds the threshold; and when the integrated voltage exceeds the threshold: stop integrating the light energy at a final voltage; and store a particular digital scaling code for the particular time interval; a digitizer to digitize the final voltage into a digital value; and an image processor to compute a light measurement based on the digital value and the particular digital scaling code.

In some aspects, the techniques described herein relate to a light imager, wherein: the time intervals include successively increasing time intervals; and the digital scaling codes include successively decreasing digital scaling codes.

In some aspects, the techniques described herein relate to a light imager, wherein: the time intervals include exponentially increasing time intervals; the digital scaling codes represent successively decreasing exponents of a base; and the image processor is configured to compute by scaling the digital value by a scaling factor equal to the base raised to a power that is equal to the particular digital scaling code.

In some aspects, the techniques described herein relate to a light imager, wherein: the pixel includes a digital memory having an input to receive the digital scaling codes during the time intervals that correspond to the digital scaling codes, and the digital memory is configured to store the particular digital scaling code presented at the input when the integrated voltage exceeds the threshold.

In some aspects, the techniques described herein relate to a light imager, wherein: the pixel further includes a digital bus coupled to an output of the digital memory, wherein the image processor is configured to read the particular digital scaling code from the digital memory through the digital bus, when the integration period ends.

In some aspects, the techniques described herein relate to a light imager, wherein: the pixel includes a capacitor to integrate the signal.

In some aspects, the techniques described herein relate to a light imager, wherein: the pixel is configured to, prior to the integration period, reset the integrated voltage on the capacitor to zero.

In some aspects, the techniques described herein relate to a light imager, wherein: the image processor is configured to read the final voltage from the capacitor when the integration period ends.

In some aspects, the techniques described herein relate to a light imager, wherein stopping integrating and computing the light measurement using the particular digital scaling code avoids light saturation of the pixel, and increases a light measurement dynamic range of the pixel.

In some aspects, the techniques described herein relate to a light imager to measure light energy including: an array of pixels; a controller to divide an integration period into time intervals identified by corresponding ones of digital scaling codes; wherein each pixel is configured to: convert the light energy to a signal; integrate the signal across the time intervals into an integrated voltage; while integrating, repeatedly compare the integrated voltage against a threshold at each time interval until, at a particular time interval, a result of a compare indicates that the integrated voltage exceeds the threshold; and when the integrated voltage exceeds the threshold: stop integrating the light energy at a final voltage; and store a particular digital scaling code for the particular time interval; a digitizer to digitize final voltages from the pixels into digital values; and an image processor to compute light measurements for the pixels based on the digital values and particular digital scaling codes from the pixels.

In some aspects, the techniques described herein relate to a light imager, wherein: the time intervals include successively increasing time intervals; and the digital scaling codes include successively decreasing digital scaling codes.

In some aspects, the techniques described herein relate to a light imager, wherein: the time intervals include exponentially increasing time intervals; the digital scaling codes represent successively decreasing exponents of a base; and the image processor is configured to compute by scaling the digital values by scaling factors equal to the base raised to powers that are equal to the particular digital scaling codes from the pixels.

In some aspects, the techniques described herein relate to a light imager, wherein: each pixel includes a digital memory having an input to receive the digital scaling codes during the time intervals that correspond to the digital scaling codes, and the digital memory is configured to store the particular digital scaling code presented at the input when the integrated voltage exceeds the threshold.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method of measuring light energy received by a pixel of an imager, comprising:
converting the light energy to an electrical signal;
dividing an integration period into time intervals identified by digital scaling codes;
integrating the electrical signal across the time intervals into an integrated voltage;
while integrating, repeatedly comparing the integrated voltage against a threshold at each time interval until, at a particular time interval, a result of comparing indicates that the integrated voltage exceeds the threshold; and
when the integrated voltage exceeds the threshold:
stopping integrating the light energy received by the pixel at a final voltage;
digitizing the final voltage to a digital value;
identifying a particular digital scaling code for the particular time interval; and
computing a light measurement based on the digital value and the particular digital scaling code.

2. The method of claim 1, wherein stopping integrating and computing the light measurement using the particular digital scaling code avoids light saturation of the pixel, and increases a light measurement dynamic range of the pixel.

3. The method of claim 1, wherein:
the time intervals include successively increasing time intervals; and
the digital scaling codes include successively decreasing digital scaling codes.

4. The method of claim 3, wherein:
the successively increasing time intervals include exponentially increasing time intervals;
the successively decreasing digital scaling codes represent successively decreasing exponents of a base; and
computing includes scaling the digital value by a scaling factor equal to the base raised to a power that is equal to the particular digital scaling code.

5. The method of claim 1, further comprising:
receiving the digital scaling codes with corresponding ones of the time intervals, and presenting the digital scaling codes to an input of a digital memory;
when the integrated voltage exceeds the threshold at the particular time interval, storing the particular digital scaling code in the digital memory; and
when the integration period ends, reading the particular digital scaling code from the digital memory.

6. The method of claim 1, wherein:
integrating includes integrating the electrical signal using an integration capacitor.

7. The method of claim 1, further comprising:
prior to the integration period, resetting the integrated voltage to zero.

8. A light imager to measure light energy comprising:
a controller to divide an integration period into time intervals identified by corresponding ones of digital scaling codes;
a pixel to:
convert the light energy to a signal;
integrate the signal across the time intervals into an integrated voltage;
while integrating, repeatedly compare the integrated voltage against a threshold at each time interval until, at a particular time interval, a result of a compare indicates that the integrated voltage exceeds the threshold; and
when the integrated voltage exceeds the threshold:
stop integrating the light energy at a final voltage; and
store a particular digital scaling code for the particular time interval;
a digitizer to digitize the final voltage into a digital value; and
an image processor to compute a light measurement based on the digital value and the particular digital scaling code.

9. The light imager of claim 8, wherein:
the time intervals include successively increasing time intervals; and
the digital scaling codes include successively decreasing digital scaling codes.

10. The light imager of claim 9, wherein:
the time intervals include exponentially increasing time intervals;
the digital scaling codes represent successively decreasing exponents of a base; and
the image processor is configured to compute by scaling the digital value by a scaling factor equal to the base raised to a power that is equal to the particular digital scaling code.

11. The light imager of claim 8, wherein:
the pixel includes a digital memory having an input to receive the digital scaling codes during the time intervals that correspond to the digital scaling codes, and the digital memory is configured to store the particular digital scaling code presented at the input when the integrated voltage exceeds the threshold.

12. The light imager of claim 11, wherein:
the pixel further includes a digital bus coupled to an output of the digital memory,
wherein the image processor is configured to read the particular digital scaling code from the digital memory through the digital bus, when the integration period ends.

13. The light imager of claim 8, wherein:
the pixel includes a capacitor to integrate the signal.

14. The light imager of claim 13, wherein:
the pixel is configured to, prior to the integration period, reset the integrated voltage on the capacitor to zero.

15. The light imager of claim 13, wherein:
the image processor is configured to read the final voltage from the capacitor when the integration period ends.

16. The light imager of claim 8, wherein stopping integrating and computing the light measurement using the particular digital scaling code avoids light saturation of the pixel, and increases a light measurement dynamic range of the pixel.

17. A light imager to measure light energy comprising:
an array of pixels;
a controller to divide an integration period into time intervals identified by corresponding ones of digital scaling codes;
wherein each pixel is configured to:
convert the light energy to a signal;
integrate the signal across the time intervals into an integrated voltage;
while integrating, repeatedly compare the integrated voltage against a threshold at each time interval until, at a particular time interval, a result of a compare indicates that the integrated voltage exceeds the threshold; and
when the integrated voltage exceeds the threshold:
stop integrating the light energy at a final voltage; and
store a particular digital scaling code for the particular time interval;
a digitizer to digitize final voltages from the pixels into digital values; and
an image processor to compute light measurements for the pixels based on the digital values and particular digital scaling codes from the pixels.

18. The light imager of claim 17, wherein:
the time intervals include successively increasing time intervals; and
the digital scaling codes include successively decreasing digital scaling codes.

19. The light imager of claim 18, wherein:
the time intervals include exponentially increasing time intervals;
the digital scaling codes represent successively decreasing exponents of a base; and
the image processor is configured to compute by scaling the digital values by scaling factors equal to the base raised to powers that are equal to the particular digital scaling codes from the pixels.

20. The light imager of claim 17, wherein:
each pixel includes a digital memory having an input to receive the digital scaling codes during the time intervals that correspond to the digital scaling codes, and the digital memory is configured to store the particular digital scaling code presented at the input when the integrated voltage exceeds the threshold.
